(19) United States
(12) Patent Application Publication
(10) Pub. No.: US 2006/0191305 A1
(43) Pub. Date: Aug. 31, 2006

(54) Security Lock Cylinder Mechanism

(76) Inventors: Vitaly Nikolaevich Golubev, Oktyabrya, g. Ufa (RU); Juriy Anatolievich Ivanov, Moscow (RU); Galina Ivanovna Chivikina, Moscow (RU)

Correspondence Address: SMITH HOPEN, PA, 180 PINE AVENUE NORTH, OLDSMAR, FL, 34677, US

(21) Appl. No.: 11/380,022

(22) Filed: Apr. 25, 2006

(30) Foreign Application Priority Data
Oct. 13, 2004 (WO) PCT/RU04/00403

(51) Int. Cl. E05B 47/00

(52) U.S. Cl. 70/276

(57) ABSTRACT

The invention relates to a security lock cylinder mechanism exhibiting high anti-pick and anti-burst characteristics. The invention mechanism (1) comprises a body consisting of two parts one of which is used as a lid and embodied in the form of a cylinder (15, 16) which are coxially arranged with respect to each other. A stem (17) is arranged in the small cylinder (16) and mechanically engaged with the lock matrix (9). The structural design of the cylinder mechanism makes it possible to incorporate mechanism into any mortise door lock.

### CROSS REFERENCE TO RELATED APPLICATIONS

This application is a continuation of PCT Application No. PCT/RU2004/000403, filed Oct. 13, 2004, which claims benefit of Russian Application No. 2003131706, filed Oct. 30, 2003.

### TECHNICAL FIELD

The present invention relates to locking devices.

### BACKGROUND ART

Known in the present state of the art is a security mechanism used in a magneto-optic security lock (cf RU Pat. #2,117,128 C1, IPC⁷ E05B 27/10, published Aug. 10, 1998, Bulletin of Inventions #22). Said security mechanism has its blocking members appearing as magnetosensitive balls which are disposed in cylindrical chambers which are established by a space confined between the bases of blind holes in the tilting yoke and the recessed end faces of the matrix inserts, at least one of said recesses being shaped eccentrically. The yoke is spring-actuated and longitudinally movable and the matrix is freely rotatable round its own axis.

A socket key of the lock has seats accommodating the inserts with orienting magnets determining position of the balls in said cylindrical chambers of the yoke when the key gets in contact with the security mechanism in the course of closing (opening) the lock. The yoke with the orienting magnets is spring-actuated and turnable independently.

Closest to the proposed invention as to its technical essence is a security mechanism of a door lock without a key hole (cf RU Pat. #2,156,343, IPC⁷ E05B 27/10 published Sep. 20, 2000, Bulletin of Inventions #26), said mechanism comprising a body which accommodates a spring-actuated longitudinally movable yoke, a matrix with inserts and a yoke, blocking members appearing as balls, a socket key with orienting magnets, said key being adapted to mate with the yoke end surface, said recesses in the inserts are made for a depth exceeding half the diameter thereof and are provided with elastic members, and the end surfaces of both the yoke and the key have peripherally arranged grooves and tongues. The key is put to the yoke end surface in a direction square therewith.

The security mechanisms known heretofore suffer from the following disadvantages:

a total lack of protection against mechanical attacks upon the yoke end face (piercing, cutting, etc. Yoke strength depends solely on the properties of a non-magnetic yoke material which are much lower than those of hardenable structural steels;

too a complicated bringing of the key into the working position, especially under bad light, which is accounted for by too small dimensions of the grooves in the body and yoke as well as of the key wards;

complicated and inadequately reliable holding of the lock in the door;

inapplicability of the herein-discussed mechanisms in mass-produced cylinder locks (which make up the bulk of locks in common use heretofore), thus placing great limitation upon their field of application and affecting adversely consumer properties thereof

### SUMMARY OF THE INVENTION

The present invention is aimed at developing a security lock cylinder mechanism featuring high anti-pick and anti-burst characteristics due to a novel construction arrangement of the mechanism body.

The object of the invention is accomplished due to the fact that in a security lock cylinder mechanism comprising a body, a spring-actuated longitudinally movable matrix, inserts adapted to enter into the matrix and mounted in a holder, blocking members arranged in gaps established between the end surfaces of the matrix and of the inserts facing each other, and a key with operating magnets, according to the invention, one of the body component parts serving as a lid and accommodating the matrix and inserts thereof appears as a cup provided with grooves on the end and lateral surfaces thereof serving for putting the key into said grooves, the handle of the key having a shoulder arranged lengthwise the key longitudinal axis and having the shape and dimensions to suit those of the groove on the end surface of said lid; the matrix has a guide slot for the key to receive, and the other body component part accommodating the holder of the inserts appears as larger-diameter cylinder and a smaller-diameter cylinder, both arranged coaxially with respect to each other; the smaller-diameter cylinder accommodates a stem mechanically engageable with the matrix and provided with a cam rotatably mounted in the slot of a retainer which extends over the surface of the smaller-diameter cylinder and has a hole for holding the cylinder mechanism in the lock; in addition, the end surface of the larger-diameter cylinder facing the holder has at least one recess the size of which exceeds the insert width.

The object of the invention is accomplished also due to the fact that a security lock cylinder mechanism comprising a body, a spring-actuated longitudinally movable matrix, inserts adapted to enter into the matrix and mounted in a holder, blocking members arranged in end gaps established between the end surfaces of the matrix and of the inserts facing each other, and a key with operating magnets, according to the invention, one of the body component parts serving as a lid and accommodating the matrix and inserts thereof appears as a cup provided with grooves on the end and lateral surfaces thereof, the matrix has a guide slot for the key to receive and an axle passing through the groove on the end surface of said lid, and the other body component part accommodating the holder of the inserts appears as larger-diameter cylinder and a smaller-diameter cylinder arranged coaxially with respect to each other; the smaller-diameter cylinder accommodates a stem mechanically engageable with the matrix and provided with a cam rotatably mounted in the slot of a retainer which extends over the surface of the smaller-diameter cylinder and has a hole for holding the cylinder mechanism in the lock; in addition, the end surface of the larger-diameter cylinder facing the holder has at least one recess the size of which exceeds half the insert width, and the key remains immovable during operation of the cylinder mechanism.

The mechanism proposed herein, due to its armored body protects the matrix end surface against drilling-out and milling-off;

provision of a holed retainer renders the security cylinder mechanism applicable in cylinder locks of any type;

unlike the cylinder mechanisms now available provision of a solid axle in the herein-proposed construction arrangement which passes through the entire cylinder mechanism protects it against breakage at the point of its attachment to the lock in case of an attempt to exert force on the mechanism;

besides, provision is made for blocking the cylinder mechanism in response to an attempt to exert force on the end surface of the matrix;

provision of guides and absence of wards and slots on the key surface for orienting it in the lock body enable one to easily use the key even in the thick dark.

### BRIEF DESCRIPTION OF THE DRAWINGS

In what follows the present invention will now be disclosed in a detailed description with reference to the accompanying drawings, wherein, according to the invention:

FIG. 1 is a view of one of the variants of the security lock mechanism when closed;

FIG. 2 is a view on arrow A;

FIG. 3 shows one of the variants of the key;

FIG. 4 is a view on arrow B in FIG. 1;

FIG. 5 is a section along V-V in FIG. 1;

FIG. 6 is a view on arrow C in FIG. 3;

FIG. 7 is a view of a security lock mechanism when open after having been installed and after the key has been turned into working position;

FIG. 8 is a section along VIII-VIII in FIG. 7;

FIG. 9 is a view of a security lock mechanism at the instant of arresting following an impact effect on the matrix front portion;

FIG. 10 is another variant of a security lock mechanism less a key;

FIG. 11 is a security lock mechanism with a key;

FIG. 12 is another variant of the key;

FIG. 13 is a view on arrow D in FIG. 10; and

FIG. 14 is a view of a security lock mechanism as presented in FIG. 11 when open after having been installed and after the key has been turned.

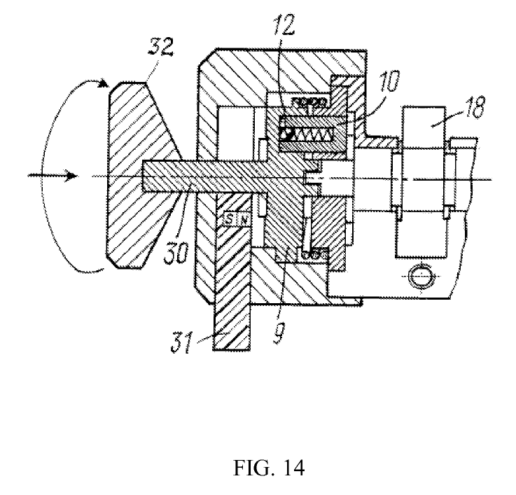

### BEST MODE OF CARRYING OUT THE INVENTION

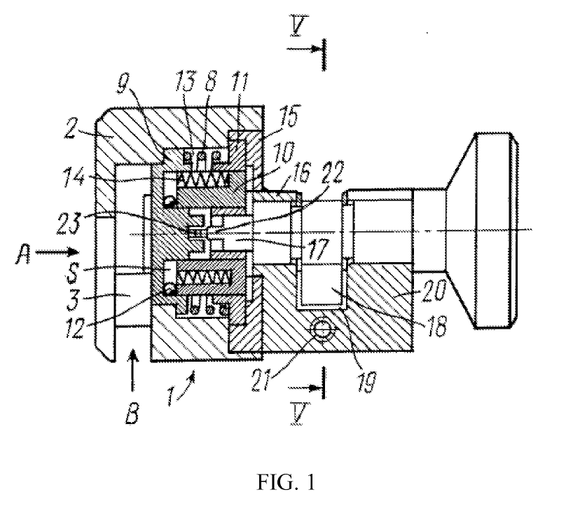

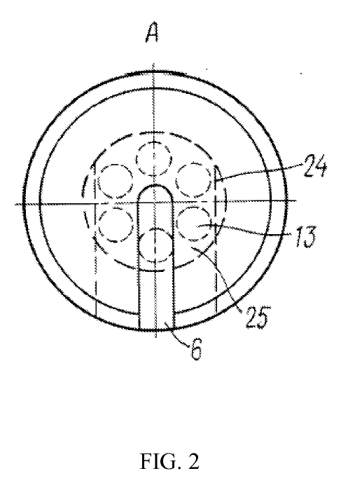

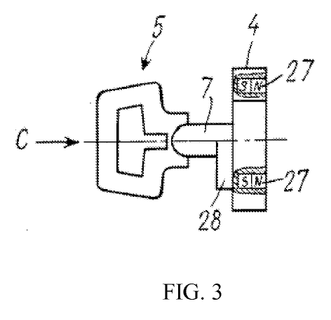

The security lock cylinder mechanism of the present invention comprises a body 1 (FIGS. 1, 2) one of the component parts thereof appears as a cup 2 serving as a lid whose lateral surface has a slot 3 for a body 4 (FIG. 3) of a key 5 to receive, while the end surface of the cup 2 having a slot 6 (FIG. 2) for a handle 7 of the key 5 to insert. The lock body 1 accommodates a matrix 9 actuated by a spring 8 and inserts 10 arranged in a holder 11, said matrix and said inserts being spaced somewhat apart and arranged coaxially with respect to each other. The inserts 10 are adapted to engage the matrix 9 to establish there between wherein blocking members 12 are arranged appearing as, e.g., magnetosensitive balls. The matrix 9 is mounted rotatably round its own axis and longitudinally movably for a width of the clearance S when no blocking members 12 are present therein. The holder 11 is mounted freely rotatably round its axis, and the end face of each insert 10 has a hole 13 wherein an elastic member may be arranged, such as a spring 14.

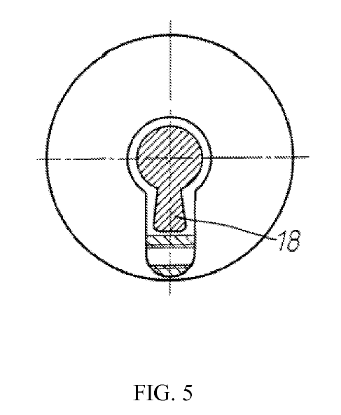

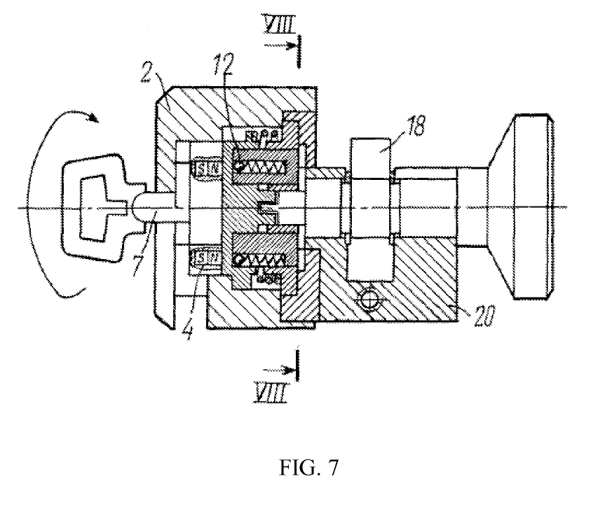

The holder 11 is installed in the other lock component part appearing as a larger-diameter cylinder 15 and a smaller-diameter cylinder 16 arranged coaxially with respect to each other. The cylinder 16 accommodates a stem 17 provided with a cam 18 (FIGS. 5, 7) rotatable in a slot 19 (FIG. 1) of a retainer 20 which extends over the surface of the smaller-diameter cylinder 16 and has a hole 21 (FIG. 1) for holding the cylinder mechanism in the body of a stock-produced cylinder lock.

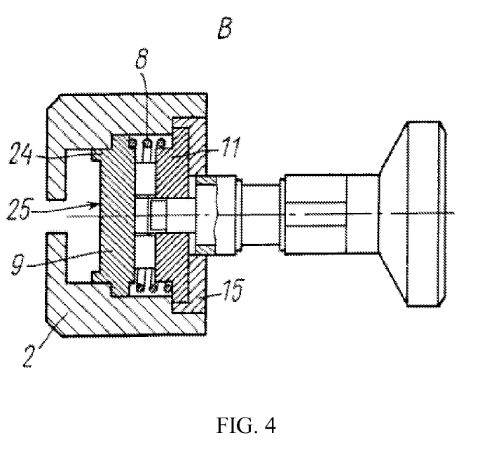

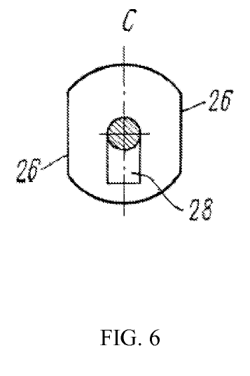

The matrix 9 (FIG. 1) and the stem 17 are mechanically engageable with each other; e.g., a ward 22 and a recess 23 are provided on the respective end surfaces of the stem 17 and the matrix 9 facing each other, said ward and said recess being adapted to interact upon longitudinal motion of the matrix 9. The opposite end surface of the matrix 9 (FIG. 4) has wards 24 between which a guide slot 25 is formed for receiving the body 4 of the key 5 whose lateral surface has guides 26 (FIG. 6) which together with the handle 7 orient operating magnets 27 (23) with respect to the holes 13 in the inserts 10. The handle 7 has a projection 28 (FIGS. 3, 6) whose shape and dimensions correspond to those of the slot 6 on the end surfaces of the lid 2.

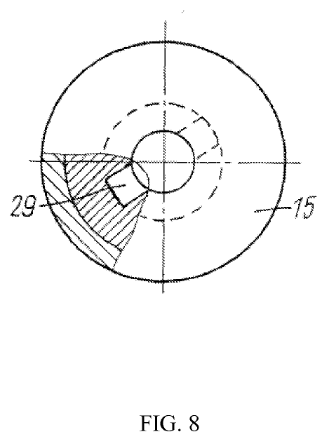

The end surface of the larger-diameter cylinder 15 (FIG. 8) facing the inserts 10 has at least one recess 29 the size of which exceeds the width of the respective insert 10.

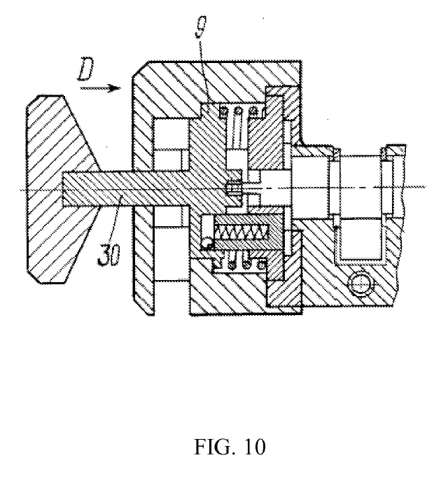

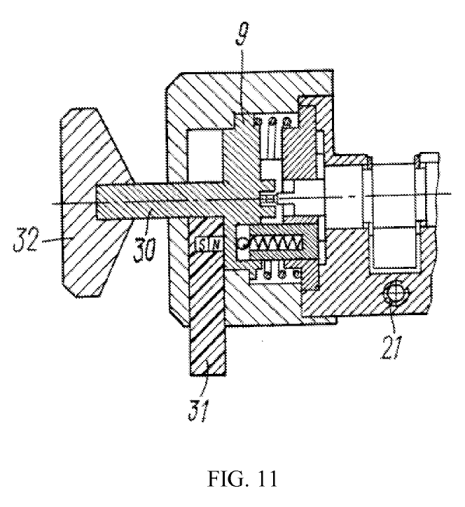

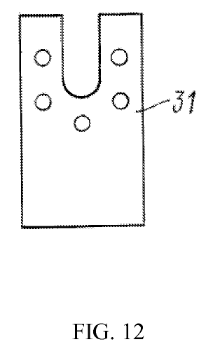

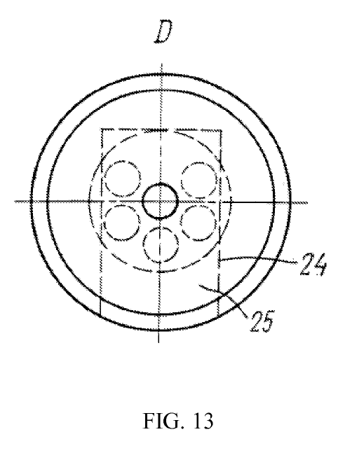

FIG. 10 presents a variant of the security lock mechanism, wherein the matrix 9 is provided with an axle 30 passing through the slot 6 provided on the end surfaces of the lid 2. Said variant of the mechanism makes use of a flat key 31 (FIGS. 11, 12) which is put into the slot 3 on the lateral surface of the lid 2. The key 31 is equal in width with the slot 25 (FIG. 13) of the matrix 9.

The security mechanism proposed herein according to a first variant operates as follows.

When opening/closing the lock, the body 4 (FIG. 7 of the key 5 is put into the slot 6 provided on the lateral surface of the lid 2 and moved along the guide slot 25 of the matrix 9 parallel to the surface thereof until the handle t of the key 5 gets in contact with the face of the slot 3, thus assuming the working position. As a result, the blocking members 12, while being acted upon by the operating magnets 27 are set against the respective holes 13 in the inserts 10. Upon depressing the key 5 the matrix 9 is made to move lengthwise the axis thereof for a distance equal to the width of the clearance S and gets mechanically engaged with the stem 17 after the ward 22 thereof engages the recess 23 in the matrix 9.

While being turned the key 5 causes to turn the holder 11 together with the matrix 9 and the stem 17 engaged therewith together with the cam 18, and the lock opens (closes), while the projection 28 of the lock holds the key 5 in the sunk position.

According to another variant of the construction arrangement, when opening (closing) the lock the key 31 is put all the way into the slot 3 on the lateral surfaces of the lid 2, with the result that the blocking members 12 are actuated by the operating magnets 27 to set against the respective holes in the inserts 10. When the axle 30 is depressed by a handle 32 engaged with the matrix 9, the latter is caused to move lengthwise the axle 30 for a length equal to the amount of the clearance S, thereby getting mechanically engaged with the stem 17 and the ward 22 thereof engages the recess 23 in the matrix 9. Upon turning the handle 32 (FIG. 2) the holder 11 turns, too, together with the matrix 9 and the stem 17 carrying the cam 18 and engaged with said matrix, and the lock opens (closes). While in operation the key remains fixed stationary and therefore cannot rotate.

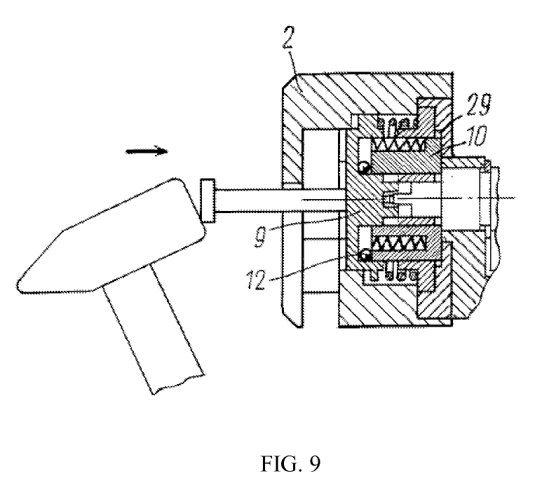

An attempt to break the lock open is illustrated in FIG. 9. In case of a force exertion upon the matrix 9, that is, when a blow is delivered against the face of matrix with a view to sink the blocking members into the body of the matrix and inserts and overpass the distances S, the blocking member squeezes the inserts 10 into the recess 29 the size of which exceeds the width of the respective insert 10, thus stopping rotation of the holder 11 with the stem 17 and the cam 18 which in turn renders opening the lock impossible.

### INDUSTRIAL APPLICABILITY

The invention proposed herein can find application in locks of diverse designs for residential and municipal buildings, as well as in locks of single-functional doors.

What is claimed is:

1. A security lock cylinder mechanism comprising a body (1), a spring-actuated longitudinally movable matrix (9), inserts (10) adapted to enter into the matrix and mounted in a holder (11), blocking members (12) arranged in clearances established between the end surfaces of the matrix (9) and of the inserts (10) facing each other, and a key (5) with operating magnets, CHARACTERIZED in that one of the component parts of the body (1) serving as a lid and accommodating the matrix (9) and the inserts (10) thereof appears as a cup (2) provided with respective grooves (3, 6) on the end and lateral surfaces thereof serving for putting the key (5) into said grooves (3, 6), a handle (7) of the key having a shoulder arranged lengthwise the key longitudinal axis and having the shape and dimensions to suit those of the groove on the end surface of said lid; the matrix (9) has a guide slot for the key to receive, and the other body component part accommodating the holder (11) of the inserts (10) appears as larger-diameter cylinder (15) and a smaller-diameter cylinder (16), both being arranged coaxially with respect to each other; the smaller-diameter cylinder (16) accommodates a stem (17) mechanically engageable with the matrix (9) and provided with a cam (18) rotatably mounted in a slot (19) of a retainer (20) which extends over the surface of the smaller-diameter cylinder (16) and has a hole (21) for holding the cylinder mechanism in the lock; in addition, the end surface of the larger-diameter cylinder (15) facing the holder (11) has at least one recess the size (29) of which exceeds the width of the insert (10).

2. A security lock cylinder mechanism comprising a body (1), a spring-actuated longitudinally movable matrix (9), inserts (10) adapted to enter into the matrix (9) and mounted in a holder (11), blocking members (12) arranged in clearances established between the end surfaces of the matrix (9) and of the inserts (10) facing each other, and a key (5) with operating magnets (27), CHARACTERIZED in that one of the component parts of the body (1) serving as a lid and accommodating the matrix (9) and the inserts (10) thereof appears as a cup (2) provided with respective grooves on the end and lateral surfaces thereof, the matrix (9) has a guide slot (3) for the key (31) to receive and an axle (30) passing through the groove (6) on the end surface of said lid (2), and the other component part of the body (1) accommodating the holder (11) of the inserts (10) appears as larger-diameter cylinder (15) and a smaller-diameter cylinder (16) arranged coaxially with respect to each other; the smaller-diameter cylinder (16) accommodates a stem (17) mechanically engageable with the matrix (9) and provided with a cam (18) rotatably mounted in the slot of the retainer (20) which extends over the surface of the smaller-diameter cylinder (16) and has the hole (21) for holding the cylinder mechanism in the lock; in addition, the end surface of the larger-diameter cylinder (15) facing the holder (11) has at least one recess (29) the size of which exceeds the width o the insert (10), and the key (5) remains immovable during operation of the cylinder mechanism.
